(19) United States
(12) Patent Application Publication
(10) Pub. No.: US 2026/0334558 A1
(43) Pub. Date: Oct. 29, 2026

(54) AEROSOL GENERATING DEVICE

(71) Applicant: KT&G CORPORATION, Daejeon (KR)

(72) Inventor: Hwikyeong AN, Seoul (KR)

(73) Assignee: KT&G CORPORATION, Daejeon (KR)

(21) Appl. No.: 19/733,773

(22) Filed: Jul. 7, 2026

Related U.S. Application Data
(63) Continuation of application No. 18/880,905, filed on Jul. 5, 2023.

(30) Foreign Application Priority Data
Jul. 7, 2022 (KR) 10-2022-0083968
Sep. 23, 2022 (KR) 10-2022-0120722

(51) Int. Cl. A24F 40/46; A24F 40/51; A24F 40/57; A24F 40/85

(52) U.S. Cl. CPC A24F 40/46; A24F 40/51; A24F 40/57; A24F 40/85

(57) ABSTRACT

An aerosol generating device according to the present disclosure includes: a body; a heater module structured to detachably couple with the body and the heater module is shaped to define a first insertion space and includes an end that is open; a heater coupled to the heater module; a memory coupled to the heater module and is configured to store information specifically associated with the heater; and a controller coupled to the body, and is configured to receive the information from the memory, and control an operation of the heater based on the information.

### DESCRIPTION

The present application is a continuation of U.S. Non-Provisional Patent Application No. 18/880,905, filed Jan. 3, 2025, which is the U.S. national phase of PCT Application No. PCT/KR2023/009534, filed Jul. 5, 2023, which claims priority to and the benefit of Korean Patent Application No. KR 10-2022-0083968, filed Jul. 7, 2022, and Korean Patent Application No. KR 10-2022-0120722, filed Sept. 23, 2022, the contents of which are incorporated herein by reference in their entireties.

### TECHNICAL FIELD

The present disclosure relates to an aerosol generating device.

### BACKGROUND ART

An aerosol generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol generating devices has been conducted.

### Disclosure of Invention

### Technical Problem

It is an objective of the present disclosure to solve the above and other problems.

It is another objective of the present disclosure to accurately calculate the temperature of a heater.

It is yet another objective of the present disclosure to accurately control a heater and other components of an aerosol generating device.

It is yet another objective of the present disclosure to facilitate cleaning of a heater module.

It is yet another objective of the present disclosure to enable easier replacement of a heater.

### Solution to Problem

According to one aspect of the subject matter described in this application, an aerosol generating device includes: a body; a heater module structured to detachably couple with the body and the heater module is shaped to define a first insertion space and includes an end that is open; a heater coupled to the heater module; a memory coupled to the heater module and is configured to store information specifically associated with the heater; and a controller coupled to the body, and is configured to receive the information from the memory, and control an operation of the heater based on the information.

### Advantageous Effects of Invention

According to at least one of the embodiments of the present disclosure, the temperature of a heater may be accurately calculated.

According to at least one of the embodiments of the present disclosure, a heater and other components of an aerosol generating device may be accurately controlled.

According to at least one of the embodiments of the present disclosure, cleaning of a heater module may be easily achieved.

According to at least one of the embodiments of the present disclosure, replacement of a heater may be easily achieved.

Further scope of applicability of the present disclosure will become apparent from the following detailed description. However, it should be understood that the detailed description and specific embodiments such as preferred embodiments of the present disclosure are given by way of example only, since various changes and modifications within the idea and scope of the present disclosure may be clearly understood by those skilled in the art.

### BRIEF DESCRIPTION OF DRAWINGS

FIGS. 1 to 11 illustrate examples of an aerosol generating device according to embodiments of the present disclosure.

### MODE FOR THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as "module" and "unit" may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms "first", "second", etc. may be used herein to describe various elements, these elements should not be limited by these terms. These terms are only used to distinguish one element from another.

It will be understood that when a component is referred to as being "connected to" or "coupled to" another component, it may be directly connected to or coupled to another component, or intervening components may be present. On the other hand, when a component is referred to as being "directly connected to" or "directly coupled to" another component, there are no intervening components present.

As used herein, a singular representation is intended to include a plural representation unless the context clearly indicates otherwise.

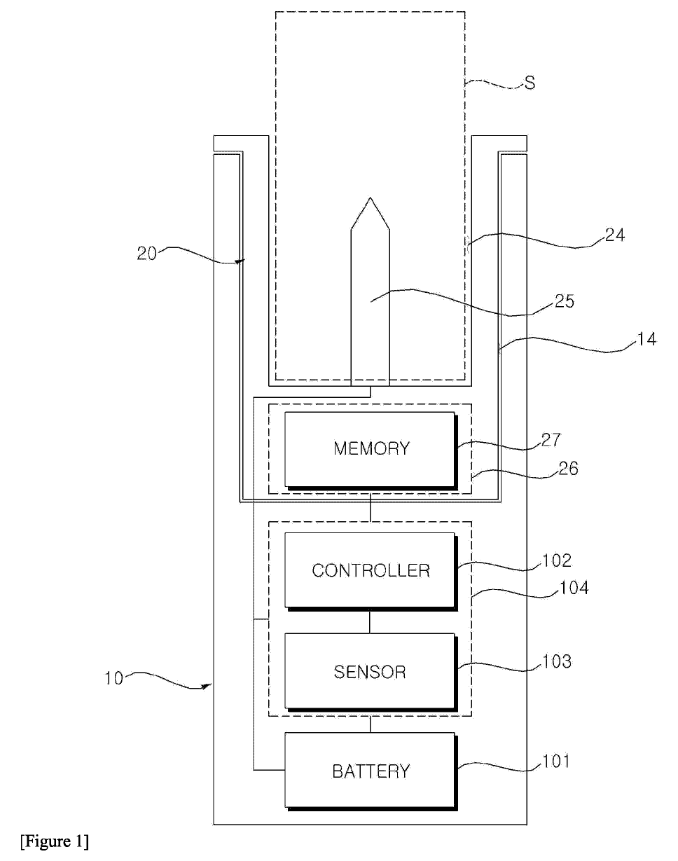

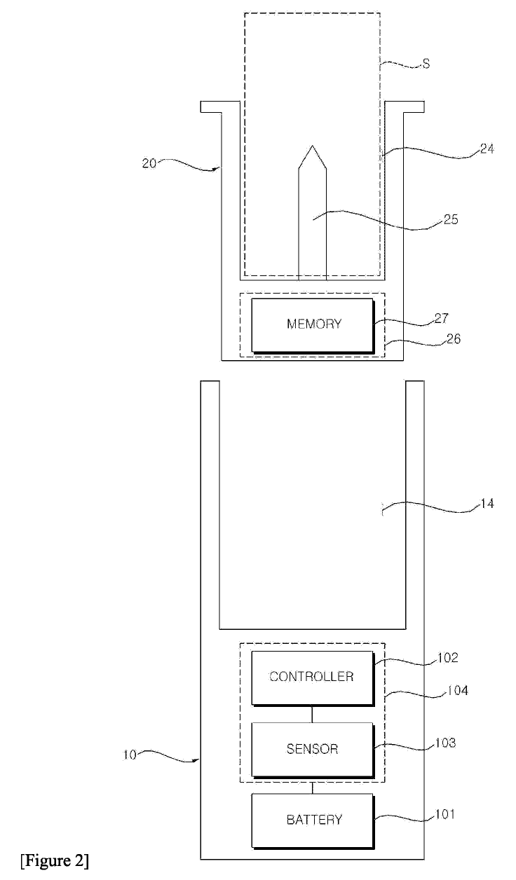

Referring to FIGS. 1 and 2, an aerosol generating device may include at least one of a battery 101, a controller 102, and a sensor 103. At least one of the battery 101, the controller 102, and the sensor 103 may be accommodated in a body 10 of the aerosol generating device. The body 10 may have a shape elongated up and down or vertically. The controller 102 and the sensor 103 may be mounted on a first substrate 104 disposed inside the body 10. The controller 102 and the sensor 103 may be mounted together on a single first substrate 104. Alternatively, the function of the sensor 103 may be embedded in the controller 102.

The battery 101 may supply power to operate components of the aerosol generating device. The battery 101 may supply power to at least one of the controller 102, the sensor 103, a heater 25, and a memory 27. The battery 101 may supply power required to operate various components, such as an induction coil (not shown), a user interface, and the like, installed at the aerosol generating device.

The controller 102 may control the overall operation of the aerosol generating device. The controller 102 may control the operation of at least one of the battery 101, the sensor 103, the heater 25, and the memory 27. The controller 102 may receive information from the sensor 103. The controller 102 may control the operation of the induction coil (not shown), the user interface, and the like installed at the aerosol generating device. The controller 102 may check the state of each of the components of the aerosol generating device to determine whether the aerosol generating device is in an operable state.

A heater module 20 may be detachably coupled to an upper part or portion of the body 10. For example, the heater module 20 and the body 10 may be coupled to each other by a magnetic force, in a snap-fit manner, or by a screw. The heater module 20 may have a first insertion space 24 that is open at top. The first insertion space 24 may have an elongated cylindrical shape. The body 10 may have a second insertion space 14 into which the heater module 20 is detachably inserted. The second insertion space 14 may be formed on the upper portion of the body 10 and may be open at top.

The heater module 20 may include the heater 25. The heater 25 may heat the first insertion space 24. For example, the heater 25 may have an upwardly tapered shape protruding from a bottom of the first insertion space 24 toward the opening of the first insertion space 24. As another example, the heater 25 may have a cylindrical shape surrounding the first insertion space 24.

A stick S may be inserted into the first insertion space 24 formed in the heater module 20. The stick S may have an elongated cylindrical shape. A lower end of the stick S may be inserted into the first insertion space 24, and an upper end of the stick S may protrude to an outside of the aerosol generating device from the first insertion space 24. When the stick S is inserted into the first insertion space 24, the heater 25 may be inserted into the stick S. A user may inhale air while holding the upper end of the stick S exposed to the outside in his or her mouth. The heater 25 may heat the stick S inserted into the first insertion space 24. When the stick S is heated to a predetermined temperature by the heater 25, an aerosol may be generated from the stick S.

The heater 25 may be a resistive heater. The heater 25 may include a variable resistance metal. The heater 25 may generate heat using power received from the battery 101. Alternatively, the heater 25 may generate heat using an eddy current produced by a magnetic field, which is generated by an induction coil (not shown) surrounding the heater 25.

The heater 25 may have unique (or specific) information. The unique information of the heater 25, which is a parameter related to intrinsic properties of the heater 25, may be a parameter for determining a voltage applied to the heater 25. For example, the unique information of the heater 25 may include parameters related to the intrinsic properties of the heater 25 that affect the heating operation of the heater 25, such as a specific resistance value of the heater 25, a temperature coefficient of resistance (TCR) value (hereinafter referred to as a "TCR value") of the heater 25, an inductance value of the heater 25, a capacitance value of the heater 25, etc. The resistance value of the heater 25 may vary with temperature. When the temperature rises as the heater 25 generates heat, the resistance value of the heater 25 may increase. The resistance value at a specific temperature may vary depending on the specific resistance value and the TCR value of the heater 25.

The sensor 103 may detect a value related to the temperature of the heater 25 or a value related to the resistance of the heater 25. For example, the sensor 103 may detect a voltage value applied to the heater 25. For example, the sensor 103 may detect a current value flowing through the heater 25.

The controller 102 may receive a value detected by the sensor 103. The controller 102 may estimate the temperature of the heater 25 based on the value received from the sensor 103. For example, since the resistance value of the heater 25 varies according to the temperature of the heater 25, the controller 102 may calculate the resistance value of the heater 25 based on a current value received from the sensor 103 to determine the temperature of the heater 25. As another example, the controller 102 may receive a temperature value of the heater 25 detected by the sensor 103 to determine the temperature of the heater 25.

The unique information of the heater 25 may depend on the material properties of the heater 25, but may also be slightly changed, for example, by dimensional errors in shape, such as the length and thickness of a heating wire of the heater 25, which may occur during manufacturing. As another example, errors in the proportions of the components constituting an alloy of the heater 25, which may occur during manufacturing, may also affect the unique information of the heater 25. These are merely examples, and the factors that affect the unique information of the heater 25 are not limited thereto. Due to these factors, a difference between an estimated temperature of the heater 25 and an actual temperature of the heater 25 may occur, thereby leading to inaccurate control.

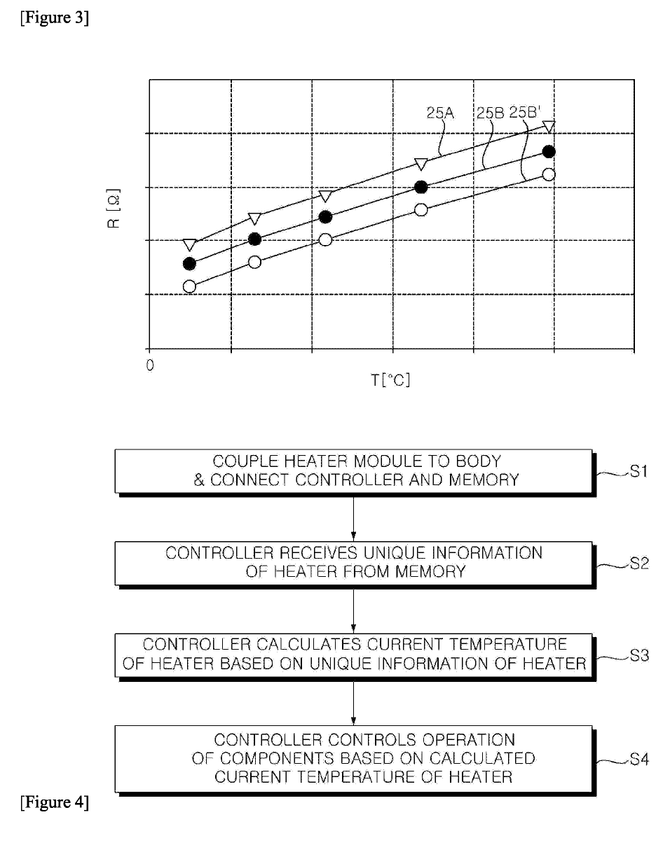

FIG. 3 is a graph showing a relationship between the resistance and the temperature of heaters having different TCR values. For example, referring to FIG. 3, a first heater 25A and a second heater 25B, which are made of the same material, may have slightly different specific resistance values and TCR values, due to an error in the ratio of an alloy occurred during manufacturing. As another example, due to foreign matter on a heat wire of the second heater 25B, a lead wire 259 or a first substrate 104 on which a controller 102 is mounted, or due to internal and external noise, the TCR value of the second heater 25B may be determined as a TCR value of a third heater 25B'.

Thus, the resistance value of the heater 25 at a specific temperature of the heater 25 may be different for the first heater 25A, the second heater 25B, and the third heater 25B'. As a result, an error in the resistance value calculated by the controller 102 may occur to thereby cause an error in calculating the temperature of the heater 25.

In order to solve this problem, the heater module 20 may include a memory 27. The memory 27 may be mounted on a second substrate 26 installed in the heater module 20. The memory 27 may store unique (or specific) information of the heater 25 included in the heater module 20.

For example, the memory 27 may store therein a specific resistance value or a TCR value of the heater 25 included in the heater module 20. When manufacturing the heater module 20, a precise unique parameter of each manufactured heater 25 may be measured by an external measuring device so as to be stored in each memory 27. Due to these reasons, specific resistance values of the heater 25 respectively stored in memories 27 included in respective heater modules 20 may be different from each other.

The controller 102 may store information corresponding to a plurality of heater parameters. For example, the controller 102 may store temperature (T)-resistance value (R) curve information for each heater parameter (see FIG. 3). For example, the controller 102 may store information corresponding to the plurality of heater parameters in the form of a look-up table. The controller 102 may receive unique information about the heater 25 from the memory 27 included in the heater module 20 to match the unique information about the heater 25 with any one of the stored plurality of heater parameters. For example, the controller 102 may match the received unique information about the heater 25 with a specific heater parameter on a temperature (T)-resistance value (R) curve.

Referring also to FIG. 4, when the heater module 20 is coupled to the body 10, the heater 25 may be electrically connected to at least one of the battery 101, the controller 102, and the sensor 103 (see step S1 in FIG. 4). When the heater module 20 is coupled to the body 10, the memory 27 may be electrically connected to at least one of the battery 101 and the controller 102 (see step S1 in FIG. 4). When the heater module 20 is removed from the body 10, the heater 25 may be separated from the battery 101, the controller 102, and the sensor 103. When the heater module 20 is removed from the body 10, the memory 27 may be separated from the battery 101 and the controller 102.

The controller 102 may receive unique information of the heater 25 from the memory 27 (see step S2 in FIG. 4). For example, the controller 102 may receive a specific resistance value of the heater 25 from the memory 27. For example, the controller 102 may receive a specific TCR value of the heater 25 from the memory 27. However, these are merely examples, and the present disclosure is not limited thereto. The controller 102 may receive various unique information of the heater 25 for estimating the temperature of the heater 25.

The controller 102 may calculate the temperature of the heater 25 based on the unique information of the heater 25 (see step S3 in FIG. 4). For example, referring to FIG. 3, the controller 102 may receive a TCR value of the heater 25 corresponding to the first heater 25A from the memory 27, and receive a current value flowing though the heater 25 from the sensor 103, so as to determine a current resistance value of the heater 25. Accordingly, a current temperature of the heater 25 corresponding to the first heater 25A may be estimated.

Thus, the controller 102 may calculate an exact temperature of the heater 25. By determining the exact temperature of the heater 25, the controller 102 may perform more precise control for various components (see step S4 in FIG. 4).

For example, the controller 102 may control the temperature of the heater 25 based on the calculated temperature of the heater 25. The controller 102 may control a voltage applied to the heater 25 to increase or decrease a heating temperature of the heater 25, thereby adjusting the temperature of the heater 25 to a target temperature. As another example, the controller 102 may determine whether liquid stored in a cartridge (not shown) is exhausted based on the current temperature of the heater 25. As another example, the controller 102 may control the user interface to provide a user with information regarding the current temperature of the heater 25.

The memory 27 may store therein identification information for identifying whether the heater module 20 is authentic (real). When the heater module 20 is coupled to the body 10, the controller 102 may receive identification information stored in the memory 27 to determine whether the heater module 20 is authentic. For example, the controller 102 may compare embedded information with the identification information to determine whether the heater module 20 is authentic. For example, the memory 27 may store identification information about the heater module 20 in the form of an encrypted code, and the controller 20 may decode the encrypted code to determine whether the heater module 20 is authentic.

For example, when the heater module 20 is fake, the controller 102 may cut off power supply to the heater 25, whereas when the heater module 20 is real, the controller 102 may control such that power is supplied to the heater 25. The controller 102 may control the user interface to provide a user with information on whether the heater module 20 is authentic.

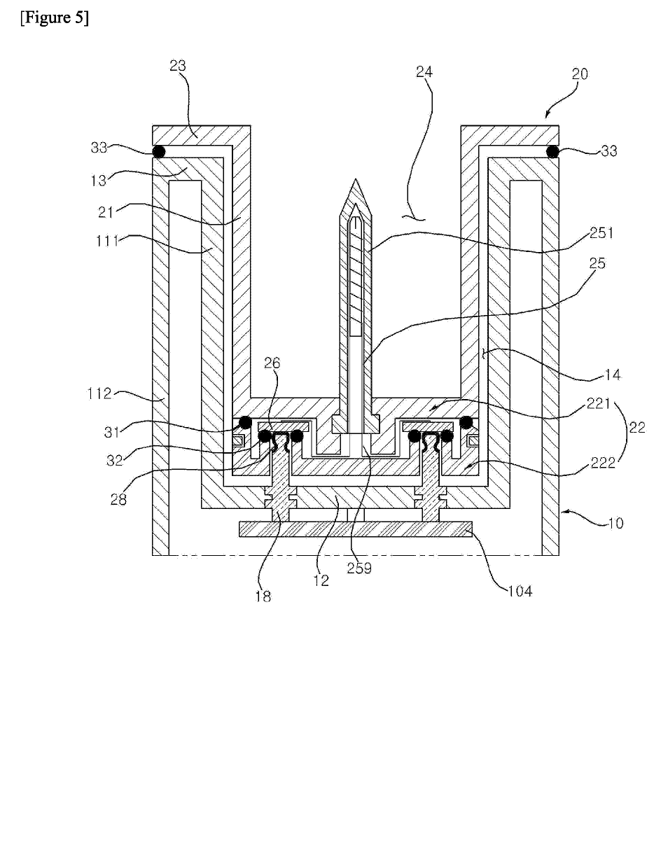

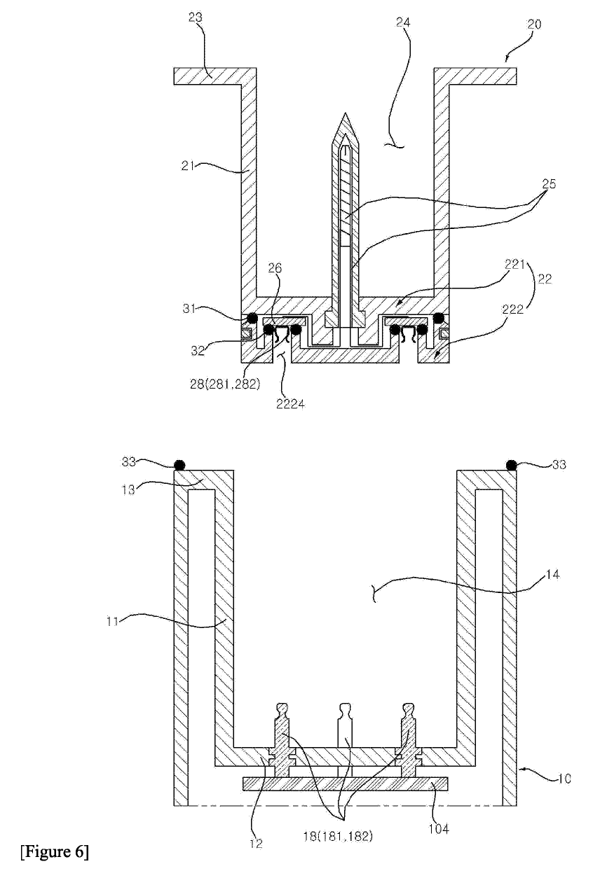

Referring to FIGS. 5 and 6, the heater module 20 may have the first insertion space 24 that is open at top. The heater module 20 may include the heater 25. The heater 25 may be fixed to the heater module 20. The heater 25 may heat the first insertion space 24. The first insertion space 24 may have a cylindrical shape elongated vertically.

A lateral wall 21 of the heater module 20 may surround a lateral circumference of the first insertion space 24. The lateral wall 21 of the heater module 20 may have a cylindrical shape elongated vertically. The lateral wall 21 of the heater module 20 may be referred to as a pipe portion 21.

The heater module 20 may include a mount 22. The mount 22 may be formed at a lower end of the heater module 20. The mount 22 may cover a lower end of the first insertion space 24. The mount 22 may be connected to a lower end of the pipe portion 21. The mount 22 may have a disc-shaped (or disk-shaped) circumference.

The heater module 20 may include an extension portion 23. The extension portion 23 may extend in a horizontally outward direction from an upper end of the pipe portion 21, and may cover at least a portion of an upper end of the body 10. The extension portion 23 may be referred to as a rim portion 23.

The heater module 20 may include a heater rod 251. The heater rod 251 may be fixed to the mount 22, so as to protrude to the first insertion space 24. The heater 25 may be inserted into the heater rod 251. The heater rod 51 may include a cavity that is open at bottom. The heater rod 251 may surround the heater 25. The heater rod 251 may have a cylindrical shape. The heater rod 251 may have a sharp or pointed upper end. The heater rod 251 may have high thermal expandability, excellent thermal insulation, and low thermal conductivity. The heater rod 251 may have high rigidity. For example, the heater rod 251 may be made of zirconia. However, the material of the heater rod 51 is not limited thereto. Heat generated from the heater 25 may be transferred to the outside through the heater rod 251. When the stick S is inserted into the first insertion space 24, the heater rod 251 and the heater 25 may be disposed inside the stick S.

A lead wire 259 may extend from the heater 25 to an outside of the heater rod 251 through the opening at the bottom of the heater rod 251. A first end of the lead wire 259 may be connected to the heater 25, and a second end of the lead wire 259 may be connected to the second substrate 26. The heater 25 and the second substrate 26 may be electrically connected via the lead wire 259. For example, the lead wire 259 may be connected to the heater 25 and the second substrate 26 by a welding process such as soldering or ultrasonic welding. The lead wire 259 may be electrically connected to the battery 101, the controller 102, and the sensor 103 through a circuit pattern printed on the second substrate 26.

Accordingly, the heater 25 may receive power through the lead wire 259 to thereby generate heat. In addition, the sensor 103 may detect, through the lead wire 259, a value related to the temperature of the heater 25 or a value related to the resistance of the heater 25. The controller 102 may receive the value detected by the sensor 103. This has been described above, and thus, a description thereof will be omitted.

A lower end of the heater rod 251 may be buried in the mount 22. The heater rod 251 may be protrude long upward from the mount 22 toward the first insertion space 24. The heater module 20 may be insert-injected with the heater rod 251. In this case, the heater module 20 may be injected by inserting the heater rod 251 into an injection mold and then injecting a polymer resin into the injection mold. In a state where the heater 25 and the lead wire 259 are disposed inside the heater rod 251, a polymer resin may be injected while the heater rod 251 is being inserted into an injection mold.

The body 10 may have the second insertion space 14 that is open at top. An inner lateral wall 111 of the body 10 may surround a lateral circumference of the second insertion space 14. The inner lateral wall 111 of the body 10 may have a cylindrical shape elongated vertically. A lower wall 12 of the body 10 may cover a bottom of the second insertion space 14. The lower wall 12 of the body 10 may be connected to a lower end of the inner lateral wall 111 of the body 10. An upper wall 13 of the body 10 may extend outward from an upper end of the inner lateral wall 111. The upper wall 13 of the body 10 may connect the upper end of the inner lateral wall 111 and an upper end of an outer lateral wall 112.

The pipe portion 21 and the mount 22 of the heater module 20 may be detachably inserted into the second insertion space 14. The pipe portion 21 of the heater module 20 may be surrounded by the inner lateral wall 111 of the body 10. The mount 22 may cover the lower wall 12 of the body 10. The extension portion 23 of the heater module 20 may cover the upper wall 13 of the body 10. A user may remove the heater module 20 from the body 10 by holding the extension portion 23. By removing the heater module 20 from the body 10, the user may clean the heater module 20 more easily. The heater module 20 may be replaced.

An extension portion sealer 33 may seal between the heater module 20 and the body 10. The extension portion sealer 33 may be disposed between the extension portion 23 and the upper wall 13 of the body 10, so as to seal between the extension portion 23 and the upper wall 13 of the body 10. When the heater module 20 is coupled to the body 10, the extension portion 23 may press the extension portion sealer 33 toward the upper wall 13 of the body 10. The extension portion sealer 33 may prevent foreign matter from entering the second insertion space 14, through a gap between the body 10 and the heater module 20, from the outside. The extension portion sealer 33 may be made of a material having elasticity. For example, the extension portion sealer 33 may be made of a rubber or silicone material. The extension portion sealer 33 may be referred to as an outer sealer 33.

Thus, foreign matter such as liquid may be prevented from being introduced into the second substrate 26 inside the mount 22.

A first terminal 18 may be coupled to the body 10. The first terminal 18 may be exposed to the second insertion space 14. For example, the first terminal 18 may protrude upward from the lower wall 12 of the body 10 toward the second insertion space 14. The first terminal 18 may be electrically connected to the first substrate 104 on which the controller 102 is mounted. The first substrate 104 may be installed in the body 10.

The heater module 20 may include the second substrate 26 on which the memory 27 (see FIG. 1) is mounted. The second substrate 26 may be installed inside the mount 22. The heater module 20 may include a second terminal 28 that is electrically connected to the second substrate 26. The second terminal 28 may be exposed to the outside from the mount 22. For example, the second terminal 28 may be exposed downward. The second terminal 28 may be disposed in a terminal groove 2224 formed in the mount 22. The terminal groove 2224 may be open at a bottom of the mount 22.

When the heater module 20 is coupled to the body 10, the second terminal 28 may come into contact with the first terminal 18. The first terminal 18 may be inserted into the terminal groove 2224 so as to be in contact with the second terminal 28. When the second terminal 28 and the first terminal 18 come into contact with each other, the memory 27 and the controller 102 may be electrically connected to each other. When the second terminal 28 and the first terminal 18 come into contact with each other, the memory 27 and the battery 101 may be electrically connected to each other. When the second terminal 28 and the first terminal 18 come into contact with each other, the heater 25 and the controller 102 may be electrically connected to each other. When the second terminal 28 and the first terminal 18 come into contact with each other, the heater 25 and the sensor 103 may be electrically connected to each other. When the second terminal 28 and the first terminal 18 come into contact with each other, the heater 25 and the battery 101 may be electrically connected to each other.

The second terminal 28 may include a portion recessed upward and having an inverted 'U' shape. The second terminal 28 may have a shape that is open at bottom. Side portions of the second terminal 28 may extend downward from opposite side edges of the second terminal 28. The side portions of the second terminal 28 may have elasticity so as to be pivoted in and out of the second substrate 26. The side portions of the second terminal 28 may have an inwardly protruding (or curved) shape. Accordingly, the first terminal 18 may be press-fitted into the second terminal 28.

Thus, the position of the heater module 20 may be aligned or fixed with respect to the body 10. In addition, the heater module 20 may be removed from the body 10 when force of a predetermined load or more is applied. This may prevent the heater module 20 from shaking with respect to the body 10 when a user uses the aerosol generating device, thereby improving the structural stability. Also, foreign matter such as liquid may be prevented from coming into contact with the second terminal 28 of the heater module 20.

The first terminal 18 and the second terminal 28 may electrically connect the memory 27 and the controller 102. The first terminal 18 and the second terminal 28 may electrically connect the heater 25 and the battery 101. The first terminal 18 and the second terminal 28 may electrically connect the heater 25 and the sensor 103.

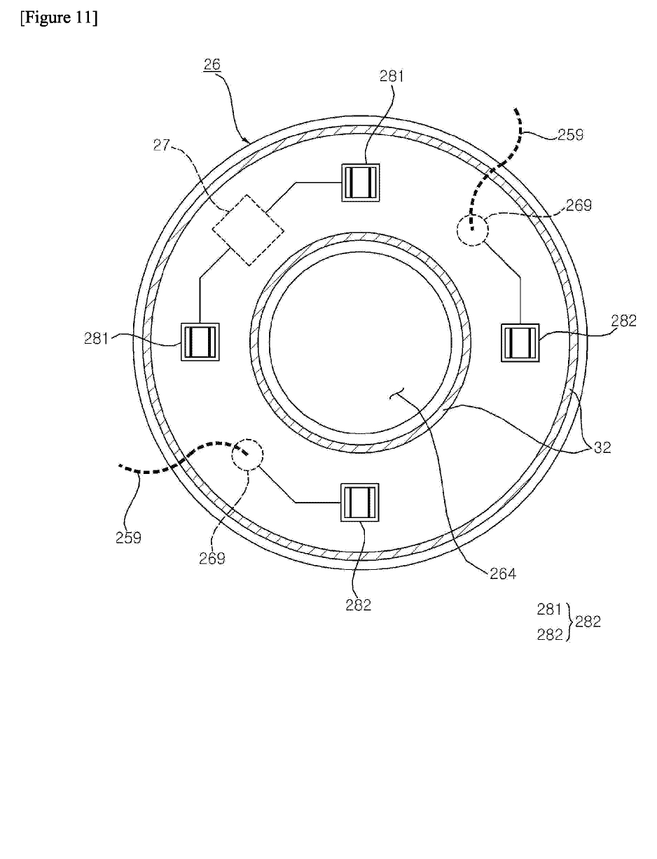

The first terminal 18 may include a first memory terminal 181. The first memory terminal 181 may be provided as a pair of first memory terminals 181. The first memory terminal 181 may be installed on the first substrate 104 to which the controller 102 is mounted, so as to be connected to the controller 102. The second terminal 28 may include a second memory terminal 281. The second memory terminal 281 may be provided as a pair of second memory terminals 281. The second memory terminal 282 may be installed on the second substrate 26 to which the memory 27 is mounted, so as to be connected to the memory 27 (see FIG. 11). The first memory terminal 181 and the second memory terminal 281 may come into contact with each other to achieve an electrical connection. Accordingly, the memory 27 and the controller 102 may be electrically connected to each other, allowing the controller 102 to receive unique information of the heater 25 from the memory 27.

The first terminal 18 may include a first heater terminal 182. The first heater terminal 182 may be provided as a pair of first heater terminals 182. The first heater terminal 182 may be connected to the battery 101 side. The first heater terminal 182 may be installed on the first substrate 104, so as to be connected to a power supply circuit pattern mounted on the first substrate 104. The second terminal 28 may include a second heater terminal 282. The second heater terminal 282 may be provided as a pair of second heater terminals 282. The second heater terminal 282 may be connected to the heater 25 and the lead wire 259 side. The second heater terminal 282 may be installed on the second substrate 26, so as to be connected to a power supply circuit pattern mounted on the second substrate 26. The first heater terminal 182 and the second heater terminal 282 may come into contact with each other to thereby achieve an electrical connection. Accordingly, the heater 25 may generate heat using power supplied from the battery 101.

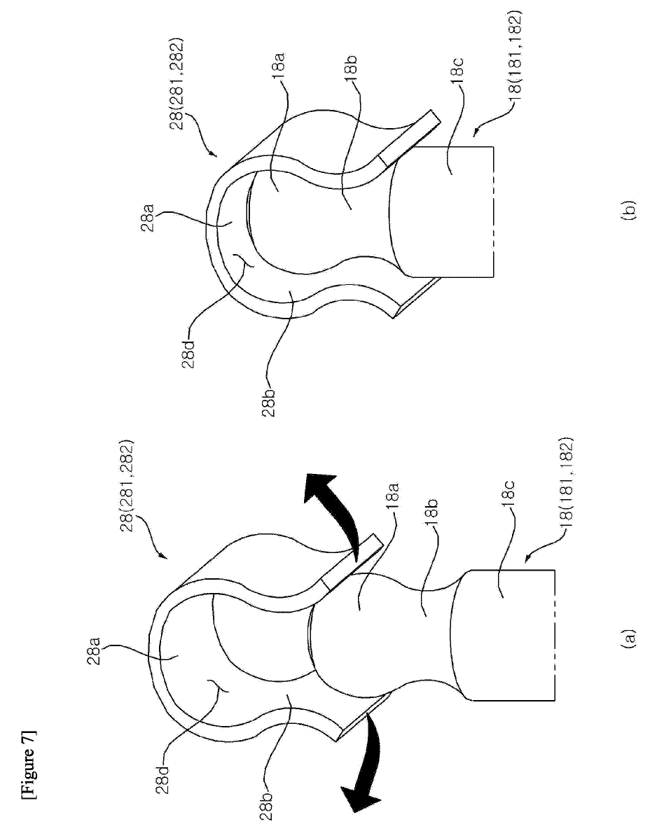

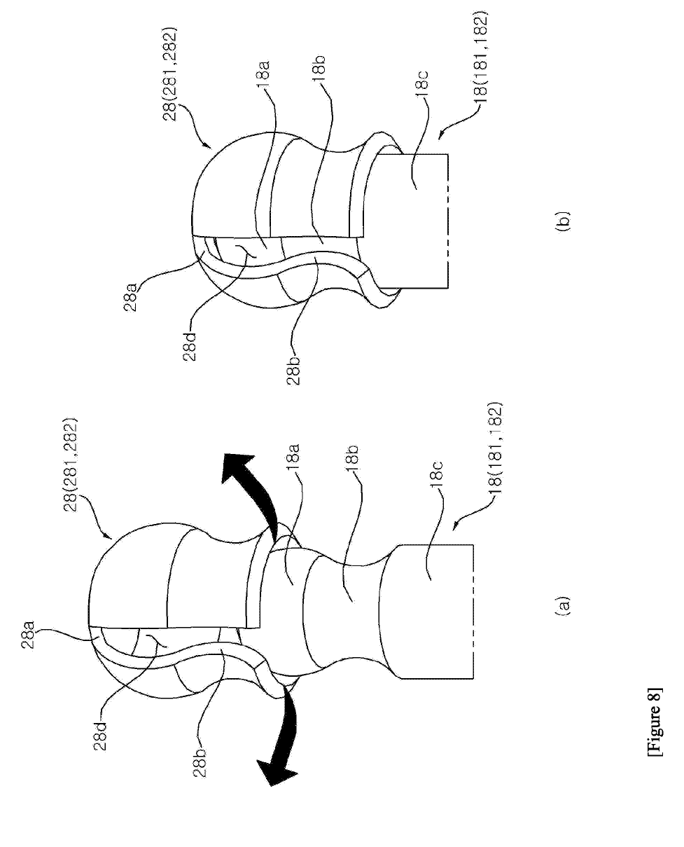

Referring to FIGS. 7 and 8, in addition to FIG. 6, the first terminal 18 and the second terminal 28 may have various shapes. The first terminal 18 may protrude upward from the lower wall 12 of the body 10 toward the second insertion space 14. The second terminal 28 may open at bottom. The first terminal 18 may be detachably inserted into the second terminal 28 so as to come into contact therewith. The first terminal 18 may be press-fitted into the second terminal 28.

In one example, the first terminal 18 may include a first terminal head 18a, a first terminal recess 18b, and a first terminal body 18c. The first terminal head 18a may be formed at an upper end of the first terminal 18. The first terminal head 18a may bulge outward or have a round shape. The first terminal recess 18b may be formed between the first terminal head 18a and the first terminal body 18c. The first terminal recess 18b may be recessed radially inward from the first terminal head 18a and the first terminal body 18c. The first terminal body 18c may be elongated downward from the first terminal recess 18b. The first terminal body 18c may have a cylindrical shape. The first terminal body 18c may be fixed to the lower wall 12 of the body 10.

In one example, the second terminal 28 may include a second terminal body 28a and a second terminal wing 28b. The second terminal body 28a may be depressed upward (i.e., concave downward) or have a round shape. The second terminal body 28a may have a curvature corresponding to the first terminal head 18a.

Referring to FIG. 7, the second terminal wing 28b may be provided in plurality. The plurality of second terminal wings 28b may be spaced apart from each other, and may extend downward from an end portion of the second terminal body 28a. A pair of second terminal wings 28b may extend downward from opposite ends of the second terminal body 28a. The pair of second terminal wings 28b may be disposed opposite each other with respect to a terminal insertion portion 28d. Alternatively, referring to FIG. 8, the second terminal wing 28b may extend downward along a circumference of the second terminal body 28a, and at least one side thereof may be vertically cut out. The second terminal wing 28b may surround a circumference of the terminal insertion portion 28d.

The terminal insertion portion 28d may be defined by the second terminal body 28a and the second terminal wing(s) 28b. The terminal insertion portion 28d may be open at bottom. The second terminal wing(s) 28b may bulge inward toward the terminal insertion portion 28d. The second terminal wing(s) 28b may have a curvature corresponding to the first terminal recess 18b. A lower portion of the second terminal wing(s) 28b may have an outwardly widening shape.

The first terminal 18 may be inserted into the terminal insertion portion 28d. The second terminal wing(s) 28b may be tilted inward and outward with respect to the second terminal body 28a. When the first terminal 18 is inserted into the terminal insertion portion 28d, the first terminal head 18a may come into contact with a lower inner surface of the second terminal wing(s) 28b. The first terminal head 18a may push the second terminal wing(s) 28b to cause the second terminal wing(s) 28b to spread outward. Then, the first terminal head 18a may be inserted into the terminal insertion portion 28d so as to be covered by the second terminal body 28a. The second terminal wing(s) 28b may be tilted inward with respect to the second terminal body 28a so as to be restored to an original position thereof, allowing the second terminal wing(s) 28b to be inserted into and engaged with the first terminal recess 18b. Upon removal of the first terminal 18 from the terminal insertion portion 28d, the first terminal head 18a may push to spread out the second terminal wing(s) 28b so as to be separated from the terminal insertion portion 28d. The second terminal wing(s) 28d may be tilted outward only when a predetermined force or more is applied from the first terminal 18.

Accordingly, the first terminal 18 may be press-fitted into the second terminal 28, allowing the first terminal 18 to be securely coupled to the second terminal 28.

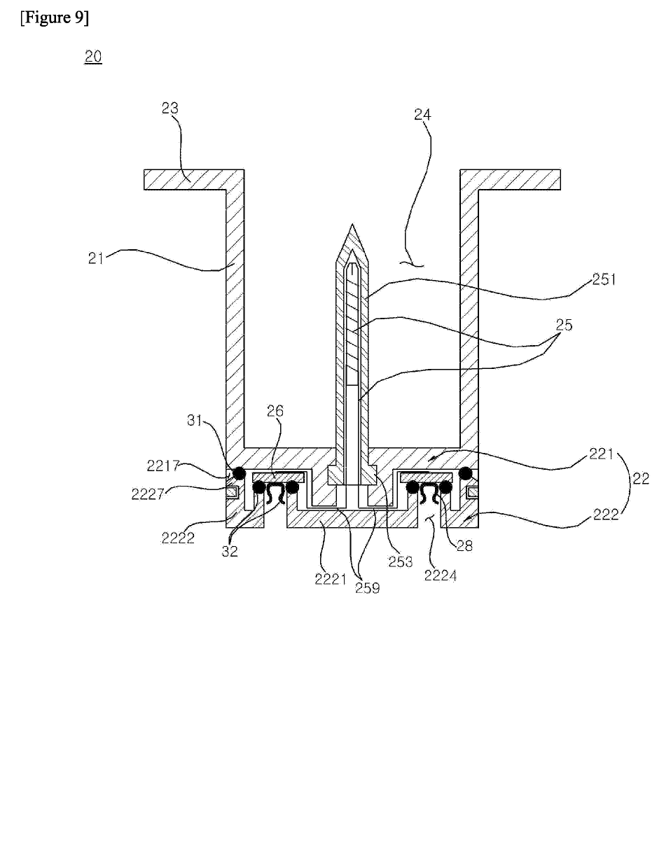

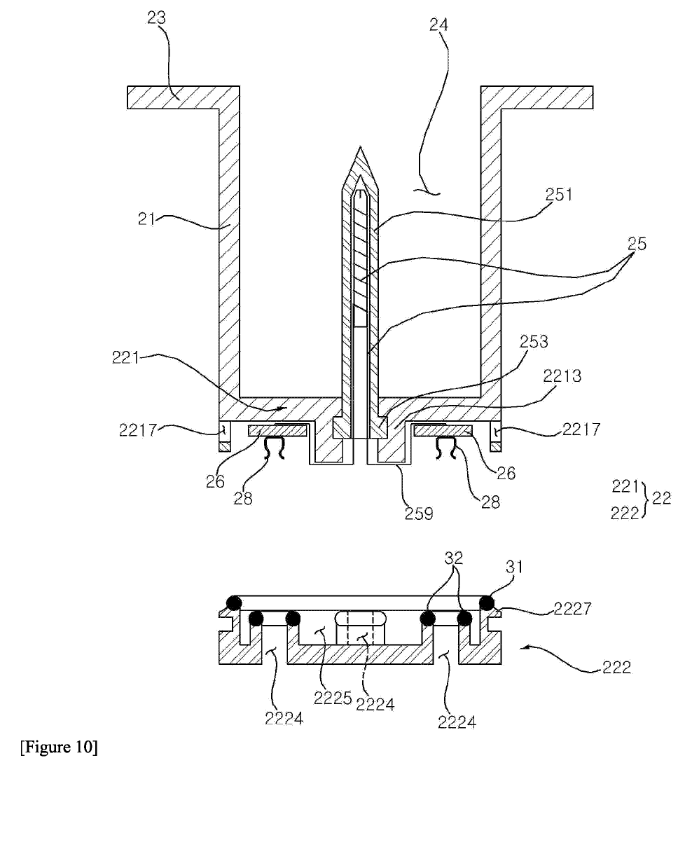

Referring to FIGS. 9 and 10, the mount 22 may include a first mount 221 and a second mount 222. The first mount 221 may be connected to a lower end of the pipe portion 21. The first mount 221 may be integrally formed with the pipe portion 21. The first mount 221 may include a disc (or disk) shape. The first mount 221 may cover a lower portion of the first insertion space 24.

The first mount 221 may be insert-injected with a lower end of the heater rod 251. An outer circumferential surface of the lower end of the heater rod 251 may include a flange portion 253 protruding radially outward. The first mount 221 may surround the flange portion 253. The flange portion 253 may be fixed to the first mount 221. The flange portion 253 may be vertically supported by the first mount 221. The flange portion 253 may prevent the heater rod 251 from being vertically separated from the first mount 221. The flange portion 253 may have a non-circular cross section, so as to be engaged with the first mount 221 in a circumferential direction. The flange portion 253 may prevent the heater rod 251 from being rotated in the circumferential direction with respect to the heater module 20. A central portion of the first mount 221 to which the flange portion 253 is coupled may protrude downward. The lead wire 259 may pass through an opening formed in a center of the first mount 221 from an inside of the heater rod 251, so as to be connected to the second substrate 26 disposed under the first mount 221.

The second mount 222 may be coupled to a lower side of the first mount 221. The second mount 222 may cover a lower portion of the first mount 221. The second mount 222 may include a bottom portion 2221 and a peripheral portion 2222. The peripheral portion 2222 may extend upward from a circumference of the bottom portion 2221. The peripheral portion 2222 may have a ring shape extending in the circumferential direction. A circumference of the peripheral portion 2222 may vertically correspond to a circumference of the pipe portion 21.

The second mount 222 and the first mount 221 may be coupled to each other in a snap-fit manner. For example, the second mount 222 may include a coupling hook 2227, and the first mount 221 may include a coupling groove 2217 to which the coupling hook 2227 is fastened. The coupling hook 2227 may be provided on the peripheral portion 2222 of the second mount 222. The coupling groove 2217 may be formed adjacent to a circumference of the first mount 221. The coupling hook 2227 and the coupling groove 2217 may be respectively provided in pair on opposite sides of the mount 22 at positions corresponding to each other. Alternatively, the coupling hook 2227 may be provided on the first mount 221, and the coupling groove 2217 may be formed in the second mount 222.

The second substrate 26 may be disposed inside the mount 22. The second substrate 26 may be disposed between the first mount 221 and the second mount 222. The second substrate 26 may be surrounded by the first mount 221 and the second mount 222.

The second mount 222 may have the terminal groove 2224. The terminal groove 2224 may be open at a bottom of the second mount 222. The terminal groove 2224 may be provided in plurality corresponding to the number of second terminals 28. For example, the second terminal 28 may include a pair of memory terminals 281 and a pair of heater terminals 282, and accordingly, four terminal grooves 2224 may be provided. The second terminal 28 may be exposed to an outside of the mount 22 through the terminal groove 2224. The plurality of second terminals 28 and the plurality of terminal grooves 2224 may be spaced apart in the circumferential direction (see FIG. 9). The second substrate 26 may cover the terminal groove 2224.

A first mount sealer 31 may seal between the first mount 221 and the second mount 222. For example, the first mount sealer 31 may seal between a circumference of the second mount 222 and the circumference of the first mount 221. The first mount sealer 31 may have a ring shape extending in the circumferential direction along a circumference of the mount 22. The first mount sealer 31 may be disposed at an upper side of the peripheral portion 2222 of the second mount 222. The first mount sealer 31 may be made of a material having elasticity. For example, the first mount sealer 31 may be made of a rubber or silicone material. When the first mount 221 and the second mount 222 are coupled to each other, the second mount 222 may press the first mount sealer 31 toward the first mount 221.

A second mount sealer 32 may seal between the terminal groove 2224 and the second terminal 28. For example, the second mount sealer 32 may seal between the terminal groove 2224 and the second substrate 26. The second mount sealer 32 may seal a gap around the second terminal 28. The second mount sealer 32 may have a shape corresponding to a circumference of the terminal groove 2224. For example, the second mount sealer 32 may have a ring shape. One surface of the second mount sealer 32 may be in contact with the second substrate 26, and another surface of the second mount sealer 32 may be in contact with the second mount 222 around the terminal groove 2224. The second mount sealer 32 may be made of a material having elasticity. For example, the second mount sealer 32 may be made of a rubber or silicone material.

As the second substrate 26 is disposed inside the mount 22, the second substrate 26 and the lead wire 259 may be protected from external impact. Also, foreign matter such as liquid may be prevented from being introduced into the mount 22. In addition, a malfunction or sensing noise, due to contact of foreign matter with the lead wire 259 and the second substrate 26, may be prevented.

Further, a user may easily clean the heater module 20 by removing the heater module 20 from the body 10. As liquid is prevented from being introduced into the heater module 20, the user may clean the heater module 20 with water.

Referring to FIGS. 10 and 11, the second substrate 26 may have a circular plate shape or a disc shape. A hole 264 may be formed in a center of the second substrate 26. A central portion of the first mount 221 may pass through the hole 264 of the second substrate 26. The second substrate 26 may surround the central portion of the first mount 221. The second terminal 28 may be coupled to the second substrate 26. The second terminal 28 may include a pair of memory terminals 281 and a pair of heater terminals 282. The memory terminal 281 may be electrically connected to the memory 27 that is mounted on the second substrate 26. The memory terminal 281 may come into contact with the first terminal 18 that is connected to the controller 102. The lead wire 259 extending from the heater 25 may be connected to the second substrate 26. The lead wire 259 may be soldered to the second substrate 26. The heater terminal 282 may be electrically connected to the lead wire 259 that is connected to the second substrate 26. The heater terminal 282 may come into contact with the first terminal 18 that is connected to the battery 101. A circuit for electrically connecting the second terminal 28 and various elements may be printed on the second substrate 26.

Referring to FIGS. 1 to 11, an aerosol generating device according to an aspect of the present disclosure may include: a body; a heater module structured to detachably couple with the body and the heater module is shaped to define a first insertion space and includes an end that is open; a heater coupled to the heater module; a memory coupled to the heater module and is configured to store information specifically associated with the heater; and a controller coupled to the body and is configured to receive the information from the memory, and control an operation of the heater based on the information.

According to another aspect of the present disclosure, the aerosol generating device may further include a sensor configured to detect information associated with a temperature of the heater. The controller may be configured to: calculate the temperature of the heater, based on the information received from the memory and the information associated with the temperature of the heater received from the sensor; and control the temperature of the heater based on the calculated temperature of the heater.

According to another aspect of the present disclosure, the heater module may include: a pipe portion that defines a lateral portion of the first insertion space; and a mount that defines a portion of another end of the first insertion space. The memory may be located inside the mount.

According to another aspect of the present disclosure, the mount may include: a first portion coupled to a lower end of the pipe portion; and a second portion coupled to a lower side of the first portion. The memory may be disposed between the first portion and the second portion.

According to another aspect of the present disclosure, the aerosol generating device may further include a first sealer to seal a gap between a circumference of the first portion and a circumference of the second portion.

According to another aspect of the present disclosure, the mount may include: a coupling groove formed in any one of the first portion or the second portion; and a coupling hook provided on a remaining one of the first portion or the second portion and is positioned to couple to the coupling groove.

According to another aspect of the present disclosure, the aerosol generating device may further include: a first terminal element comprising a plurality of first terminals attached to the heater module, and the first terminal element is coupled to the memory and the heater; and a second terminal element comprising a plurality of second terminals attached to the body and is coupled to the controller, the second terminal element is structured to contact the first terminal element to permit electrical communication between the controller and the memory, and between the controller and the heater.

According to another aspect of the present disclosure, the mount may be shaped to define a terminal groove located at a bottom of the mount and is sized to receive the first terminal element.

According to another aspect of the present disclosure, the first terminal element may be shaped to define a depression, and the second terminal element may protrude upward from the body and be press-fitted into the first terminal element, through the terminal groove.

According to another aspect of the present disclosure, the aerosol generating device may further include a second mount sealer to seal a gap between the terminal groove and the first terminal element.

According to another aspect of the present disclosure, the body may be shaped to define a second insertion space that is open on one side and is sized to detachably couple with the heater module.

According to another aspect of the present disclosure, the aerosol generating device may further include an outer sealer to seal an interface between the body and the heater module.

According to another aspect of the present disclosure, the heater module may include a rim portion that extends from one end of the pipe portion in a horizontally outward direction and overlaps one end of the body. The outer sealer may seal a gap between the rim portion and the one end of the body.

According to another aspect of the present disclosure, the information specifically associated with the heater may include a parameters related to an intrinsic property of the heater that affects the operation of the heater.

Certain embodiments or other embodiments of the disclosure described above are not mutually exclusive or distinct from each other. Any or all elements of the embodiments of the disclosure described above may be combined with another or combined with each other in configuration or function.

For example, a configuration "A" described in one embodiment of the disclosure and the drawings, and a configuration "B" described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

1. An aerosol generating device comprising:
a body providing an elongated accommodation space that is open at a top;
a heater module disposed in the accommodation space and providing an insertion space into which an aerosol generating article is inserted;
a heater coupled to the heater module; and
a first sealer and a second sealer sealing the heater module or the body and disposed to be spaced apart from each other,
wherein the first sealer and the second sealer are disposed to be spaced apart from the heater in a longitudinal direction of the insertion space.

2. The aerosol generating device of claim 1, wherein the first sealer is disposed at an upper position than the heater in the longitudinal direction of the insertion space.

3. The aerosol generating device of claim 1, wherein the heater module includes a heater rod disposed in the insertion space and having a cavity formed therein, and
wherein the heater is disposed inside the cavity of the heater rod.

4. The aerosol generating device of claim 3, wherein the heater module includes a mount forming a bottom of the insertion space and fixing the heater rod, and
wherein the second sealer is disposed on one side of the mount to seal a circumference of the mount.

5. The aerosol generating device of claim 4, wherein the second sealer is disposed at a lower position than the heater in the longitudinal direction of the insertion space.

6. The aerosol generating device of claim 4, wherein the first sealer and the second sealer have a ring shape extending in a circumferential direction of the insertion space.

7. The aerosol generating device of claim 4, wherein the first sealer and the second sealer have elasticity.

8. The aerosol generating device of claim 1, wherein the heater module includes a pipe forming a circumference of the insertion space, and
wherein a gap is formed between the pipe and an inner lateral wall forming a circumference of the accommodation space.

9. The aerosol generating device of claim 4, wherein the heater is disposed to be spaced apart upward from the mount.

10. The aerosol generating device of claim 1, further comprising a battery, and
wherein the heater is configured to generate heat using power received from the battery.

11. The aerosol generating device of claim 3, wherein the heater rod is formed of a ceramic material.

12. The aerosol generating device of claim 1, further comprising a lead wire connected to the heater and transmitting power to the heater.
